(19) United States
(12) Patent Application Publication
(10) Pub. No.: US 2024/0424460 A1
(43) Pub. Date: Dec. 26, 2024

(54) STANDALONE CUSTOM COSMETICS DISPENSER

(71) Applicant: BoldHue, Inc., Aurora, CO (US)

(72) Inventors: Karin Layton, Aurora, CO (US); Charles A. Curtiss, Norwalk, CT (US)

(21) Appl. No.: 18/750,310

(22) Filed: Jun. 21, 2024

Related U.S. Application Data
(60) Provisional application No. 63/509,505, filed on Jun. 21, 2023.

(51) Int. Cl. B01F 33/84; A45D 44/00; B01F 35/21; B01F 35/71; B01F 35/90; B01F 35/92; B01F 101/21; G05D 11/13

(52) U.S. Cl. CPC B01F 33/8442; A45D 44/005; B01F 35/2131; B01F 35/7176; B01F 35/92; G05D 11/132; B01F 2035/99; B01F 2101/21

(57) ABSTRACT

A cosmetic dispenser comprising a base and a wand structure. The base includes multiple cartridge receptacles configured to receive removable cartridges. Each cartridge is configured to contain a different pigment. The base also includes multiple pumps configured to dispense pigment from the respective cartridge to a container. The wand structure includes a scanner including a skin tone sensor configured to capture data indicative of a user's skin color. The cosmetic dispenser is configured to receive the data indicative of the user's skin color from the wand structure and determine an amount of each pigment in the cartridges needed to create a cosmetic foundation having a shade of the user's skin color when combined with a foundation base. The cosmetic dispenser is configured to cause one or more of the pumps to dispense the amount of each pigment from respective cartridges needed to create the cosmetic.

### RELATED APPLICATIONS

This application claims the benefit and priority of U.S. Provisional Patent Application No. 63/509,505, filed Jun. 21, 2023, which is incorporated herein by reference in its entirety.

### BACKGROUND

Finding a foundation to match an individual's skin tone can be a difficult and burdensome process. When in search of a foundation, an individual may go to a cosmetics store where they can physically sample an array of foundations available for purchase. Not every cosmetic brand makes a wide range of shades of foundation, so the individual may have a limited selection of foundations to choose from. When assessing a foundation, their view of the foundation is affected by the lighting in the cosmetics store and which area of their body they sampled the foundation on. They may make a subjective choice about which foundation seems to match their skin tone but, after purchase, realize that the foundation does not actually match. Further, their skin tone may change based on sun exposure (or lack thereof), resulting in the foundation also not matching. These difficulties extend to other cosmetic products, such as tinted moisturizer, eye shadow, lipstick, bronzer, and blush.

Though some mobile applications allow individuals to virtually “try on” cosmetic products, these applications are also limited by lighting and often present an inaccurate view of how the cosmetic products would look on an individual. The virtual “try-ons” also deprive individuals of the opportunity to assess the coverage and feel of the cosmetic products on their skin. Thus, a system for creating personalized foundations and other cosmetic products that accurately match a user's skin tone is necessary.

### BRIEF DESCRIPTION OF THE DRAWINGS

FIG. 1 illustrates views of a cosmetic dispenser according to some embodiments of the present technology.

FIG. 2 illustrates an exploded view of exemplary inner core sub-assembly of the cosmetic dispenser according to some embodiments of the present technology.

FIG. 3 illustrates an exploded view of an exemplary bottom portion assembly of the cosmetic dispenser according to some embodiments of the present technology.

FIG. 4 illustrates views of the interior of the cosmetic dispenser according to some embodiments of the present technology.

FIG. 5 illustrates an exploded view of a scanner, a base housing, and a rear door of the cosmetic dispenser according to some embodiments of the present technology.

FIG. 6 illustrates an exemplary exploded view of the base housing of the cosmetic dispenser with a scanner coupling assembly, a top printed circuit board assembly (PCBA), and a display assembly according to some embodiments of the present technology.

FIG. 7 illustrates an exemplary exploded view of the scanner of the cosmetic dispenser according to some embodiments of the present technology.

FIGS. 8 and 9 illustrate exemplary perspective views of the scanner positioned in a cylindrical cavity of the base housing of the cosmetic dispenser according to some embodiments of the present technology.

FIGS. 10 and 11 illustrate a cartridge of the cosmetic dispenser according to some embodiments of the present technology.

FIGS. 12 and 13 illustrate removal of the cartridge from the cosmetic dispenser according to some embodiments of the present technology.

FIG. 14 illustrates exemplary views of a top portion of the cosmetic dispenser according to some embodiments of the present technology.

FIG. 15 illustrates operation of the drawer of the cosmetic dispenser according to some embodiments of the present technology.

FIG. 16 is a flow diagram that illustrates processes for operating a cosmetic dispenser according to some embodiments of the present technology.

FIG. 17 is a block diagram illustrating some components of the cosmetic dispenser.

FIG. 18 is a block diagram that illustrates an example of a computer system in which at least some operations described herein can be implemented.

### DETAILED DESCRIPTION

### Overview

Traditionally, cosmetic companies have a limited range of shades of foundation. When selecting from among the limited range, users must account for not only the color of their skin (e.g., a shade of light, fair, medium, dark) but also their undertone (e.g., warm, cool, neutral). This often requires a user to guess what foundation would be a good match when shopping online or for the user to go to a physical store to objectively select a foundation. These foundations ultimately may not match the user's skin tone in other environments or as their skin tone changes, requiring the user to begin the process of selecting a foundation again.

Described herein is a cosmetic dispenser that creates and dispenses personalized foundations and other cosmetics. The cosmetic dispenser includes mechanical and electromechanical components that function together to scan a user's skin for a skin tone, determine a pigment combination that matches the skin tone of a user's skin, and dispense the pigment combination into a container. The cosmetic dispenser can include multiple cartridges. For example, the cosmetic dispenser includes a first cartridge that contains a cosmetic base and a second cartridge that contains pigments that can be combined with the cosmetic base to create foundation to match a range of skin tones. The cartridges can be removed from the cosmetic dispenser and replaced when one or more of the pigments and/or cosmetic base runs out.

The cosmetic dispenser can be used in a user's personal environment. For example, a user can keep a cosmetic dispenser in their home to create a personalized foundation whenever they want. That way, when they run out of their foundation or their skin tone changes, they can scan their skin with the cosmetic dispenser and obtain an updated foundation without going to a cosmetics store. The container that holds the foundation is small and reusable, so the user can update their foundation frequently rather than using a large bottle over many months or purchasing a large bottle that they ultimately dispose of before it is empty. Not only is this more environmentally friendly than traditional foundations, but this is also healthier for the user as they are less likely to get an infection from fresh foundation compared to when using old or expired foundation.

The cosmetic dispenser can also be used in a cosmetics store. For example, a cosmetics store may give the device to employees to make personalized foundations for customers on the spot. The employees may also use the cosmetic dispenser to make samples for customers to try before purchase. This is cleaner than using old, singular sample bottles of foundations, which can collect bacteria over time. Using the cosmetic dispenser in this fashion can also reduce the time that customers may need to spend looking for foundations in the store and improve customer satisfaction.

Though described herein in relation to foundation, the cosmetic dispenser may also be used to create personalized versions of other cosmetics, such as blush, bronzer, lipstick, eyeshadow, and the like. By personalizing the cosmetics for a user, the user may more easily access cosmetics that naturally complement their skin tone. The cosmetic dispenser may also be used to formulate personalized skin care products by determining characteristics of a user's skin (e.g., hydrated, acne-prone, dry), hair care products by determining a hair type of the user's hair (e.g., low porosity, curly, fine), and nail care products by determining colors that complement a user's nails or address nail care needs (e.g., cuticle care, brittle nails). The cosmetic dispenser could further use the data to indicate what products a user should apply to moisturize their skin, reduce frizz in their hair, and the like. In some instances, the cosmetic dispenser could be designed to create personalized paint colors for art, walls, external structures, and the like.

Aspects and advantages of the invention will be set forth in part in the following description, or may be obvious from the description, or may be learned through practice of the invention. One exemplary aspect of the present disclosure is directed to a computer-implemented method of detecting skin tone of a user and dispensing pigments to create a personalized foundation. Other exemplary implementations of the present disclosure are directed to systems, apparatuses, non-transitory computer-readable media, devices, and user interfaces for personalized cosmetic creation and cosmetic recommendations. These and other features, aspects, and advantages of the present invention will become better understood with reference to the following description.

### System

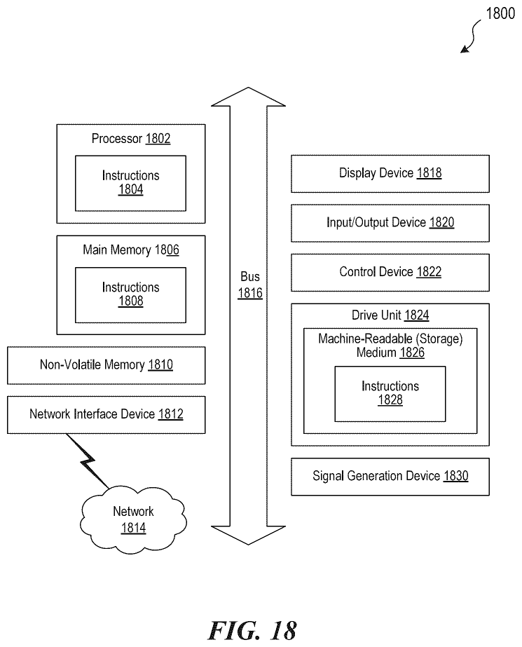

The cosmetic dispenser (or a foundation dispenser) may be a handheld or portable electronic device that includes one or more of a base, a scanner (also referred to as a “wand” herein), and one or more cartridges. The base can include a screen, buttons, a printed circuit board, a computer processor, a motor, a heater, switches, and the like. In some embodiments, the cosmetic dispenser may include additional or alternative components to those described herein. For example, the cosmetic dispenser may have a touchscreen or a screen that is communicatively connected to a series of buttons. The cosmetic dispenser can include a computer system or a portion of a computer system (e.g., a computer system 1800 described with respect to FIG. 18). The cosmetic dispenser can include one or more printed circuit boards (PCBs) or circuit board assemblies (PCBAs) configured to operate the cosmetic dispenser.

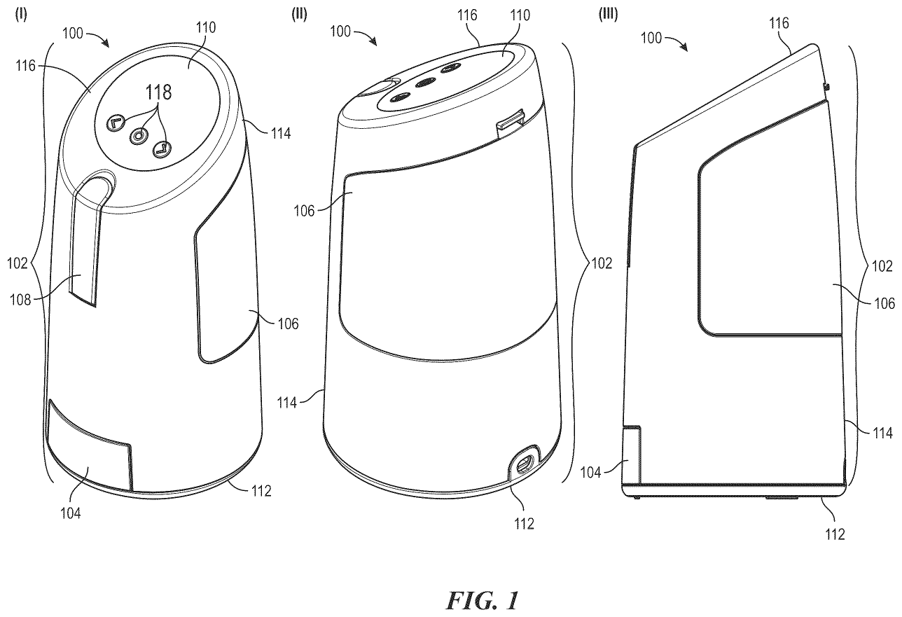

FIG. 1 illustrates views of a cosmetic dispenser 100. Section I of FIG. 1 illustrates a perspective front view of the cosmetic dispenser 100, Section II of FIG. 1 illustrates a perspective back view of the cosmetic dispenser 100, and Section III of FIG. 1 illustrates a side view of the cosmetic dispenser 100. The cosmetic dispenser 100 includes a base 102 and a removable scanner 108. The base 102 includes a base housing 114, a bottom cover 112, a top cover 116, a drawer 104, a rear door 106, control buttons 118, and a screen 110.

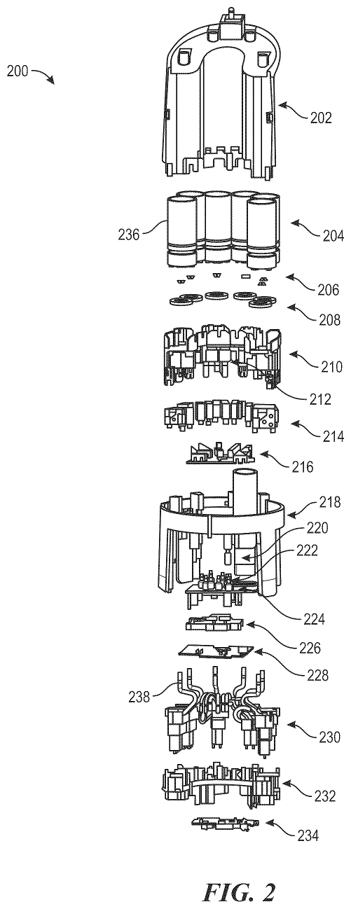

FIG. 2 illustrates an exploded view of exemplary inner core sub-assembly 200 of the cosmetic dispenser 100 of FIG. 1. The inner core sub-assembly 200 in FIG. 2 includes a back cover 202, a cartridge sub-assembly 204, pipe clamps 206, cartridge connector gaskets 208, cartridge connectors 210 with hinge shafts 212, hinge holders 214, a cartridge switch PCBA 216, an inner frame 218, a battery 220 (e.g., a lithium battery), nozzles 222, a dispensing chassis 224, light separator 226, a drip sensor PCBA 228, pumps 230 (e.g., peristaltic pumps), pump holders 232, and a motor interface PCBA 234.

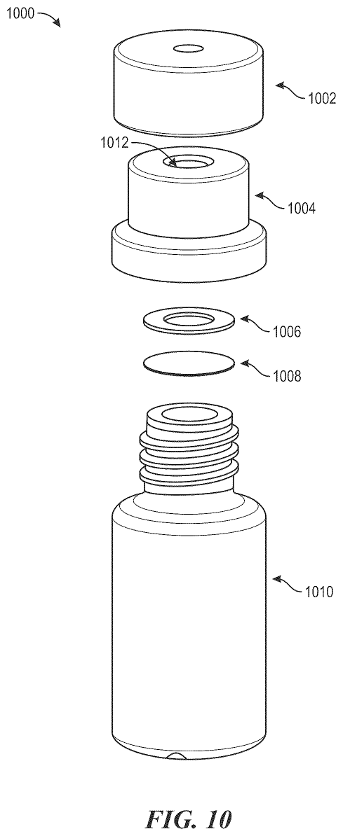

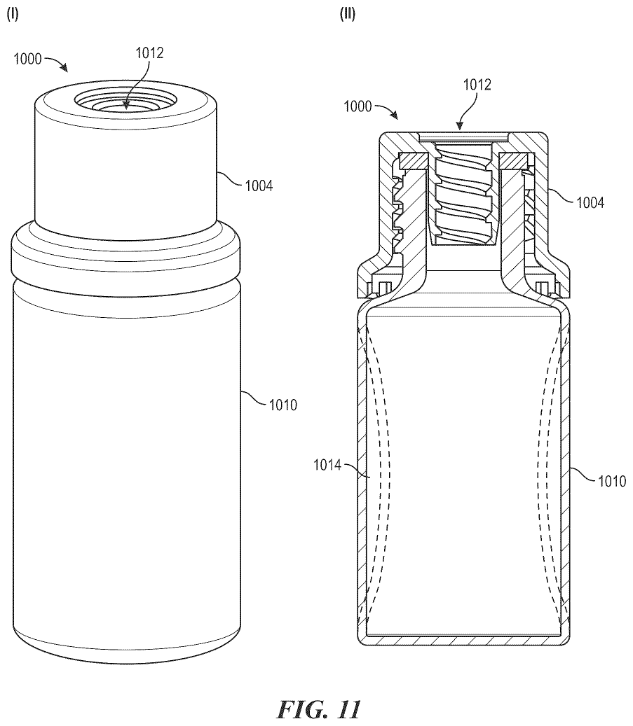

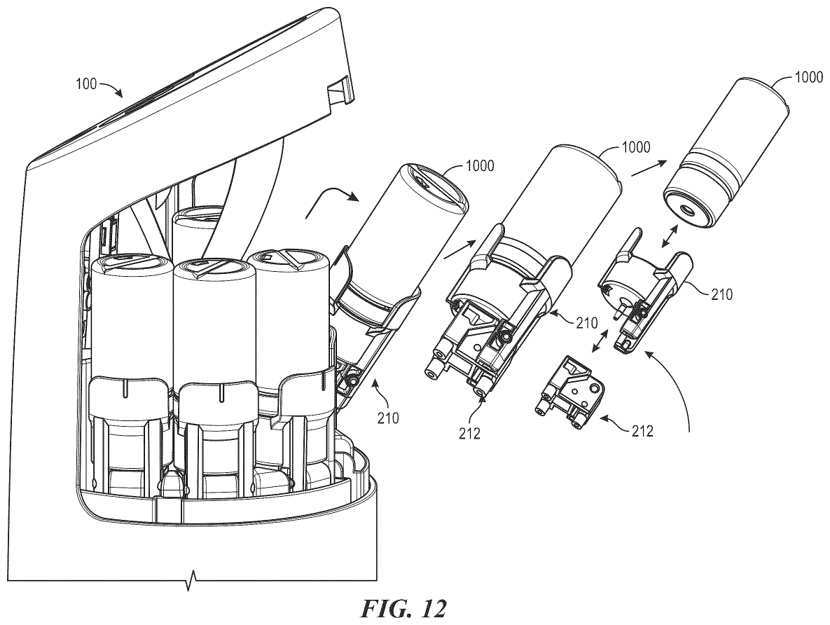

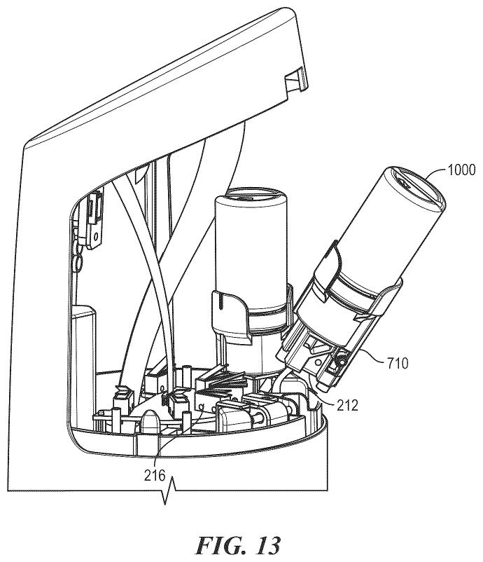

The back cover 202 and the inner frame 218 are configured to hold and provide structural support for the rest of the inner core sub-assembly 200. The back cover 202 can be positioned to couple with the cartridge sub-assembly 204. The cartridge sub-assembly 204 includes a plurality of cartridges (e.g., a cartridge 236) configured to hold one or more foundation bases and one or more pigments. The cartridges are removable from the cosmetic dispenser 100 so that the cartridges can be replaced and/or refilled. The cartridge sub-assembly 204 is configured to couple with the cartridge connector 210 so that the cartridge connector secures the cartridges and positions them so that foundation base or pigment can be dispensed from the respective cartridges to a container. In some embodiments, each of the cartridges is coupled with a pipe clamp for controlling the dispensing of a foundation base or a pigment from the respective cartridge. In some embodiments, the cartridge connector gaskets 208 are positioned between the cartridge sub-assembly 204 and the cartridge connectors 210 to facilitate mechanical coupling and positioning of the cartridge connector gaskets 208. The cartridge connector 210 is further coupled with the hinge holders 214 and the hinge shaft 212 that facilitate the coupling and decoupling of the cartridges from the cosmetic dispenser 100. The cartridges are described in detail with respect to FIGS. 10 and 11, and the coupling/decoupling of the cartridges with the cartridge connector 210 is described in detail with respect to FIGS. 12 and 13.

The cartridge sub-assembly 204 and the cartridge connectors 210 are coupled with the cartridge switch PCBA 216. The cartridge switch PCBA 216 (and other PCBAs of the cosmetic dispenser 100) can include components (e.g., such as a processor and a memory described with respect to FIG. 18) for operating one or more components of the inner core sub-assembly 200. The cartridge switch PCBA 216 can facilitate the controlled dispensing of liquids from the cartridges. The cosmetic dispenser is powered by the battery 220 that is electrically coupled to the cartridge switch PCBA 216 as well as other components of the cosmetic dispenser 100. The dispensing chassis 224 includes the multiple nozzles 222. Each of the nozzles 222 is configured to couple with the cartridges of the cartridge sub-assembly 204 to allow dispensing of a foundation base or a pigment from each of the cartridges.

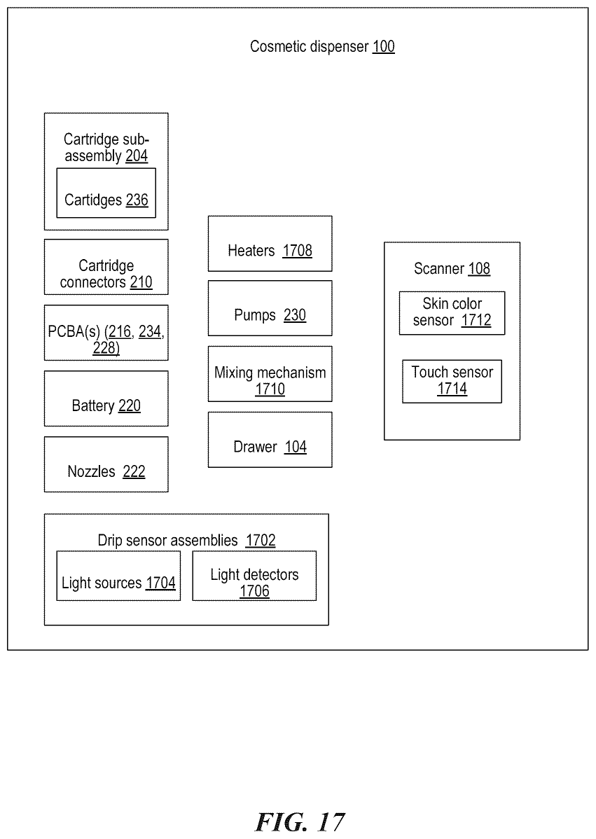

Each of the nozzles 222 is coupled to a respective pump of the pumps 230 via a respective tube (e.g., a tube 238). The pumps 230 are secured by the pump holder and operated by the motor interface PCBA 234. The pumps 230 can be peristaltic pumps. The pumps 230 control the flow of the foundation base and pigments from the cartridges. The pumps 230 are further coupled with the drip sensor PCBA 228 including components configured to detect the amount of liquid (e.g., a number of drops) that has exited each of the cartridges during dispensing of the respective foundation base and/or pigments. The drip sensor PCBA 228 can include or be coupled with multiple drip sensor assemblies including light sources (e.g., infrared (IR) light sources or emitters) and light detectors (e.g., IR detectors) (e.g., see drip sensor assemblies 1702 including light sources 1704 and light detectors 1706 in FIG. 17). Each nozzle 222 can be coupled with a drip sensor assembly on the drip sensor PCBA 228. For example, each light source is paired with a drip sensor (or other counter) that captures data used to determine how much pigment has been dispensed. The drip sensor PCBA 228 is positioned in vicinity of the drip sensor assemblies for fast data transmittal. The light separator 226 (e.g., an IR light separator) can be positioned on the PCBA 228 so that the each of the drip sensors assemblies are separated from each to avoid interference between the difference light beams.

The viscosity of the pigments can affect how quickly the pigments are able to exit each cartridge 236. The cosmetic dispenser can include one or more heaters coupled with tubes 238 and/or nozzles 222 to heat the pigments after the pigments have gone through the pumps, thus increasing flow rate (e.g., changing the viscosity) of the pigments during dispersal. For example, a heater can be positioned adjacent to, or surrounding, a tube coupled with a nozzle of a respective cartridge. The heater can be further electrically coupled with a PCBA (e.g., the cartridge switch PCBA 216, the drip sensor PCBA, or the motor interface PCBA 234).

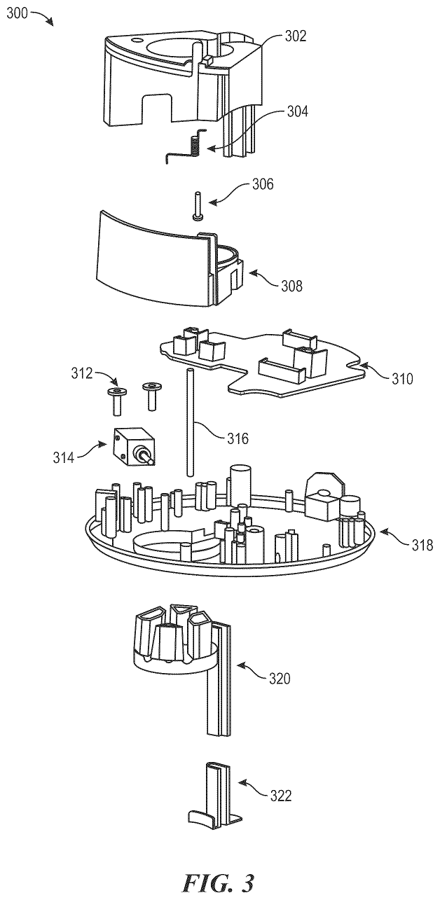

FIG. 3 illustrates an exploded view of an exemplary bottom portion assembly 300 of the cosmetic dispenser 100 of FIG. 1. The bottom portion assembly 300 includes a drawer enclosure 302, a drawer spring 304, a drawer screw 306, a drawer 308 (corresponding to the drawer 104 in FIG. 1), a bottom PCBA 310, self-tapping screws 312, a locking mechanism 314, a drafter shaft 316, a bottom cover 318, a sensor cover 320, and a sensor cover handle 322.

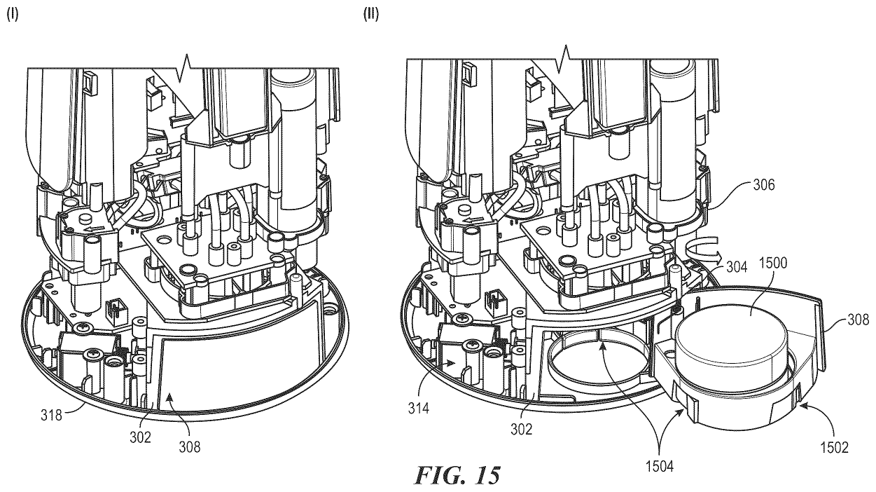

The drawer 308 is configured for holding a removable container for dispensing liquids from the cartridges described with respect to FIG. 2. The drawer 308 can be coupled with the drawer enclosure 302 and the bottom cover using the drawer spring 304, the drawer screw 306, and the drawer shaft so that the drawer 308 can pivot in and out of the cosmetic dispenser 100. The locking mechanism 314 can be configured to secure the drawer 308 when the drawer is positioned inserted within the cosmetic dispenser 100. The locking mechanism 314 can include, for example, a solenoid. The operation of the drawer 308 and drawer enclosure 302 is described in detail with respect to FIG. 15.

The bottom cover 318 corresponds to the bottom cover 112 in FIG. 1 and can be configured to receive the sensor cover 320 coupled with the sensor cover handle 322. The sensor cover 320 is configured to provide a protective shield for drip sensors described with respect to FIG. 2. The sensor cover 320 is configured to be removable so that the sensor cover 320 can be inserted and removed through the bottom cover 318 and positioned to couple with the drip sensor PCBA 228 including drip sensor assemblies. Alternatively, the drip sensor PCBA 228 can be coupled with a sensor cover that is non-removable (e.g., the sensor cover is mechanically coupled with the drip sensor PCBA 228 and is not configured to be easily removable). The sensor cover can be configured to protect the components of the drip sensor PCBA 228, such as the light detectors, from dust or staining.

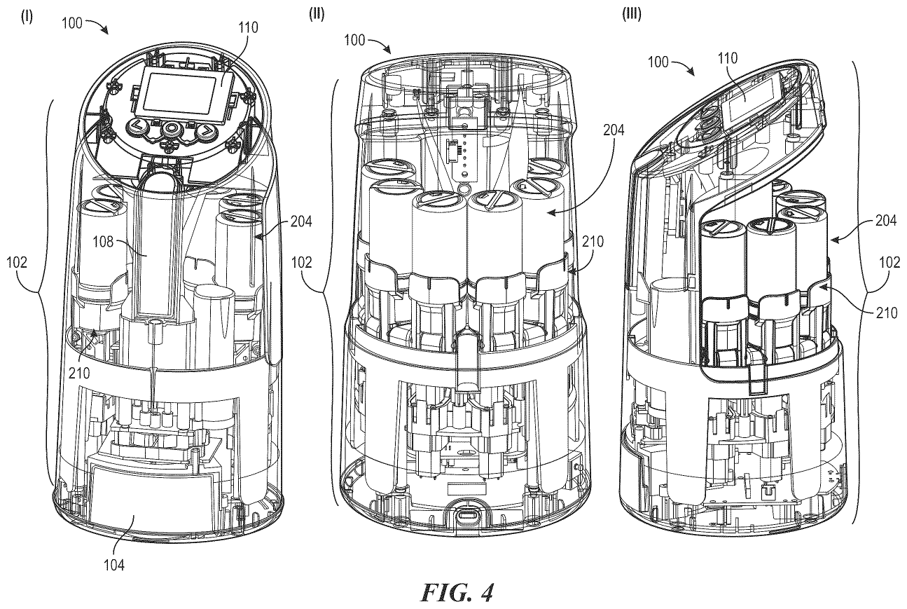

FIG. 4 illustrates views of the interior of the cosmetic dispenser 100 according to some embodiments of the present technology. Section I of FIG. 1 illustrates a front interior view of the cosmetic dispenser 100, Section II of FIG. 1 illustrates a back interior view of the cosmetic dispenser 100, and Section III of FIG. 1 illustrates a side interior view of the cosmetic dispenser 100. The interior views illustrate a portion of the components described with respect to FIGS. 2 and 3 assembled within the cosmetic dispenser 100 shown in FIG. 1 (with housing 114 and top cover 116 removed).

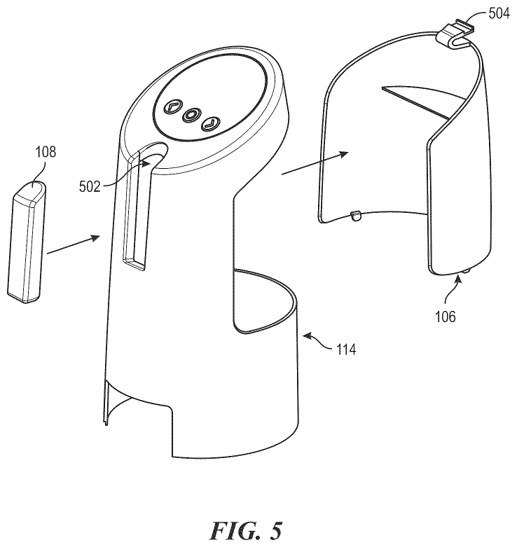

FIG. 5 illustrates an exploded view of the scanner 108, the base housing 114, and the rear door 106 of the cosmetic dispenser 100. The rear door 106 is configured to receive within a back portion of the base housing 114 and be secured within the base housing 114 with a fastener (e.g., a fastener 504). The rear door 106 can be removed to allow a user to access the interior components of the inner core sub-assembly 200 described with respect to FIG. 2. In particular, a user can use the rear door 106 to remove and replace the cartridges 236 in the cartridge sub-assembly 204 in FIG. 2. The front portion of the base housing 114 in FIG. 5 defines a cavity (e.g., a notch cavity 502) configured to receive the scanner 108. The notch cavity 502 has a shape that corresponds to the cylindrical wand-shape of the scanner 108 so that that the scanner 108 can be inserted into, and secured within, the notch cavity 502.

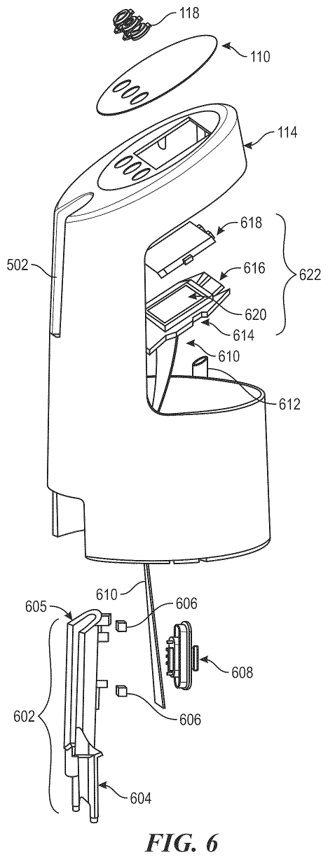

FIG. 6 illustrates an exemplary exploded view of the base housing 114 with a scanner coupling assembly 602, a top PCBA 614, and a display assembly 622 of the cosmetic dispenser 100. In FIG. 6, the scanner coupling assembly 602 includes a scanner holder 605 including an electrical connector 604 (e.g., a pogo pin PCBA holder) and an electrical connector 608. The scanner coupling assembly 602 further includes magnets 606 configured to secure the scanner 108 within the notch cavity 502. The electrical connector 608 is configured to electronically couple the scanner 108 to the top PCBA 614 via cables 610 (e.g., flexible flat cables (FFC)). The top PCBA 614 can be further coupled with a display 620 (e.g., a liquid crystal display (LCD)) coupled with the top PCBA 614 and the screen 110 with display holder 618 and a foam tape 616. The screen 110 can include a transparent cover (e.g., a sticker) that provides protection to the display 620. The control buttons 118 can be coupled with the top PCBA 614 and configured to operate as input devices for the cosmetic dispenser 100 (e.g., the control buttons 118 and the display 620 can correspond to input/output devices 1820 in FIG. 18). In some implementations, a spacer (e.g., a spacer 612) is positioned to adjust the relative positioning of the base housing 114 (e.g., shown in FIG. 5) and the rear door 106.

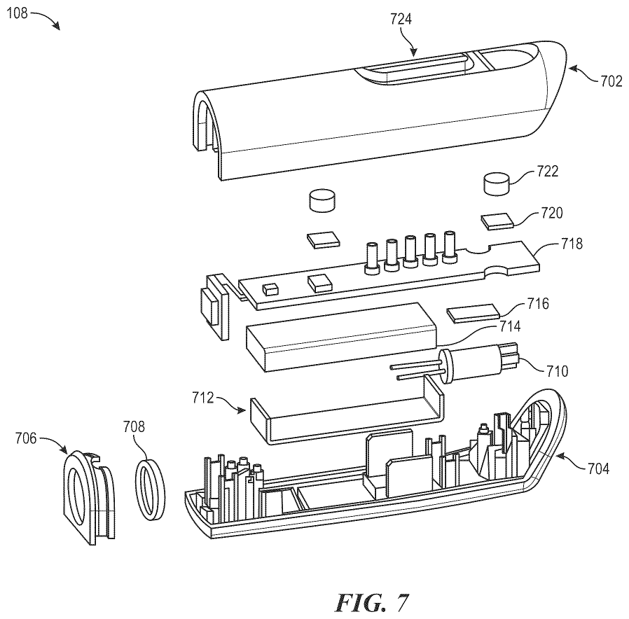

FIG. 7 illustrates an exemplary exploded view of the scanner 108 of the cosmetic dispenser 100. As shown, the scanner 108 forms a wand structure formed by a top cover 702 and a bottom cover 704. The scanner 108 also includes a lens 708 and a lens holder 706 configured to hold the lens 708 at a first end region of the scanner 108. The scanner also includes a battery 714 (e.g., a lithium battery) for powering the scanner 108, a vibration motor 710, and a wand PCBA 718. The wand PCBA 718 can include one or more sensors for detecting skin color and/or contact of the scanner with a user's skin. Foams 712, 716, and 720 (e.g., foam sheets and/or foam tape) can be included to reduce movement and vibration of the wand PCBA 718 and battery 714. The scanner 108 can further include magnets 722 configured to secure the components of the scanner together.

The scanner 108 (e.g., the wand PCBA 718) can include a skin color sensor (e.g., see a skin color sensor 1712 in FIG. 17) such as a photoelectric sensor, LiDAR sensor, or other sensor capable of capturing data describing skin tone (or shades, hues, and/or colors in other embodiments). The scanner 108 can further include a touch sensor (e.g., see a touch sensor 1714 in FIG. 17) that captures data that can be used to determine whether the user's skin is in contact with the scanner 108. In some embodiments, the vibration motor 710 can be configured to provide a haptic alert when the touch sensor detects that scanner 108 (e.g., the first end region of the scanner including the lens 708) is in contact with the user's skin. The processing of the data captured by the scanner is described below in relation to the cosmetic support platform. In some embodiments, the scanner 108 may be removed from the base housing 114 of the cosmetic dispenser 100, capture data describing a user's skin tone, and be reinserted into the cosmetic dispenser 100 for data processing.

The scanner 108 can include electrical contacts 724 that, when in contact with related contacts located within the cosmetic dispenser (e.g., the electric contacts 608 in FIG. 6), communicate that the scanner 108 is inserted within the notch cavity 502 of the base housing 114 of the cosmetic dispenser 100.

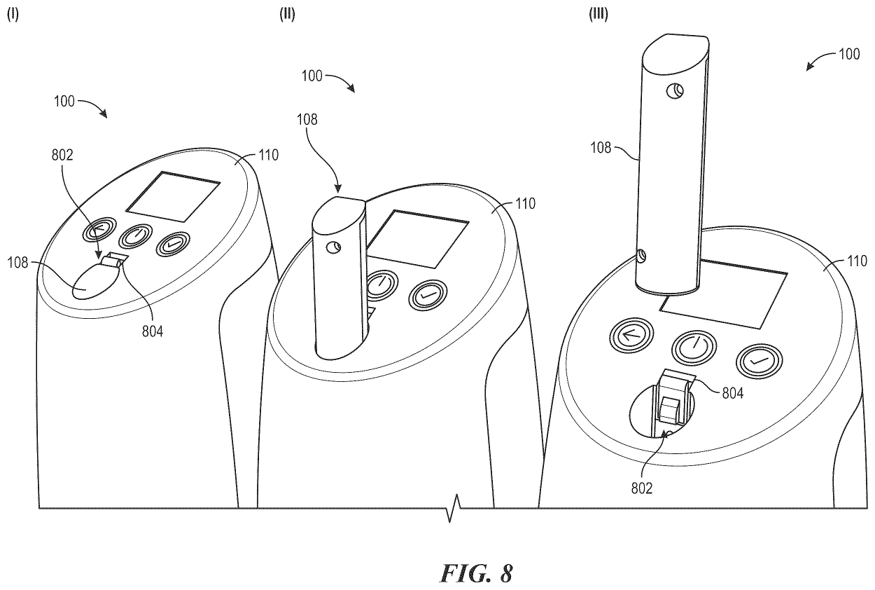

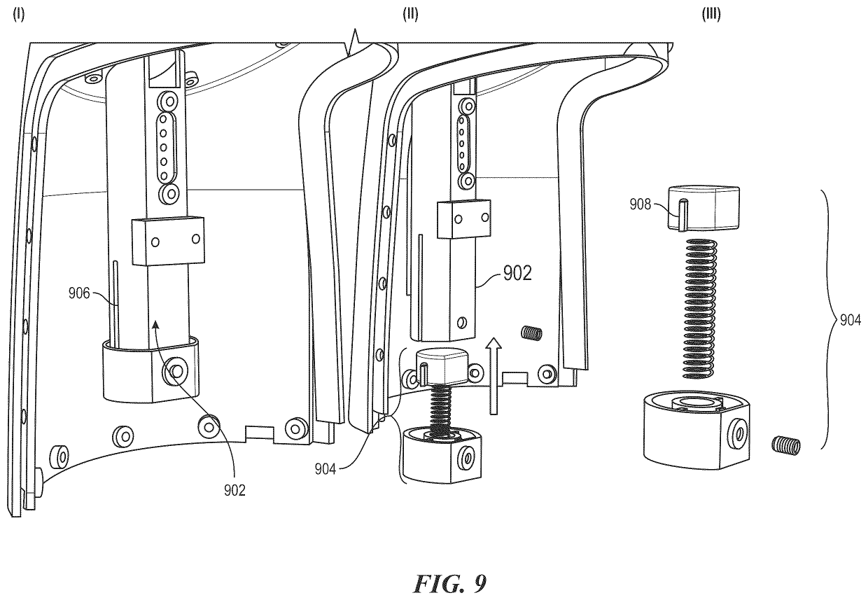

FIGS. 8 and 9 illustrate exemplary perspective views of the scanner 108 positioned in a cylindrical cavity 802 of the base housing 114 of the cosmetic dispenser 100. The embodiment of FIG. 8 corresponds to the embodiment described with respect to FIGS. 5 and 6, with the exception that in FIG. 8, the scanner 108 is configured to be positioned within a cylindrical cavity 802 having an opening on the top cover 116 of the cosmetic dispenser 100. The top cover 116 can include a fastener 804 (e.g., button or other mechanical fastener) configured to secure the scanner 108 within the cylindrical cavity 802 in Section I of FIG. 8. In Section II of FIG. 8, the fastener 804 is opened to allow the scanner 108 to be removed from the cosmetic dispenser 100, as is shown in Section II of FIG. 8.

FIG. 9 illustrates a coupling mechanism for the scanner 108 within the cylindrical cavity 802 (e.g., including an interior view of the front portion of the cosmetic dispenser 100). Section I of FIG. 9 includes a bracket 902 (e.g., a plastic bracket) that forms the cylindrical cavity 802 for holding the scanner 108. The bracket 902 can be coupled with a piston 904 (e.g., including a spring) positioned at the bottom of the bracket 902. The piston 904 includes a piston that can control the vertical movement of the scanner 108 within the bracket 902, as shown in Section III of FIG. 9. For example, when the scanner 108 is released by unfastening the fastener 804 in FIG. 8, the piston 904 pushes the scanner 108 up, as shown in Section II of FIG. 9. The scanner 108's vertical movement when within bracket 902 is limited by the piston 904. Further, a top region of the piston 904 can include tabs 908 that can be inserted within slots of 906 of the brackets to limit the horizontal movement of the piston 904 within the bracket 906.

FIGS. 10 and 11 illustrate a cartridge 1000 of the cosmetic dispenser 100. In some embodiments, the cartridge 1000 corresponds to the cartridges 236 described with respect to FIG. 2. The cartridges are configured to contain pigments and a foundation base for dispersal into a container. The pigments may include red, green, blue, black, yellow, cyan, magenta, and/or white. The foundation base is a colorless/white liquid that is formulated to create an even complexion when applied to skin. A user can select from among a range of foundation bases that have different properties. For example, if the user wants a moisturizing effect, they may select a foundation base that includes moisturizing ingredients, such as glycerin or hyaluronic acid. If the user wants a glow effect, they may select a foundation base that includes a shimmery substance, such as mica or muscovite.

FIG. 10 includes an exemplary exploded perspective view of the cartridge 1000. The cartridge 1000 includes a top cover 1012, a bottle cap 1004, a bottle gasket 1006, a foil 1008, and a bottle 1010 (e.g., an airless bottle). The bottle cap 1004 is configured to be secured within the cartridge connector 210 in FIG. 2 so that a liquid (e.g., a foundation base or a pigment) can exit the cartridge 1000 when the liquid is dispensed from the cartridge. The top cover 1002 is configured to be removed from the cartridge 1000 before coupling with the cartridge connector 210. The gasket 1006 and the foil 1008 can be positioned between the bottle 1010 and the bottle cap 1004 to form a leak-proof seal. Section I of FIG. 11 includes an exemplary coupled perspective view of the cartridge 1000 (without the top cover 1012). Section II of FIG. 11 includes an exemplary cross-sectional view of the cartridge 1000 in Section I. The cartridge 1000 includes a bag within the bottle 1010. The bag is made of a thin, flexible material that is positioned completely flushed against the interior surface of the bottle 1010 when the bag is filled with a liquid (e.g., a foundation base or a pigment). When the liquid exits the cartridge 1000, the bag is compressed from liquid being pulled out of the bottle 1010. In FIG. 11, the side surfaces of a bag are illustrated with the bracket lines 1014 to demonstrate that the bag is flexible and can conform to the shape of the liquid inside the bag.

As described with respect to FIG. 2, the cosmetic dispenser 100 includes the pumps 230. Each of the pumps 230 is coupled with a respective cartridge. The pumps 230 can be peristaltic pumps. In some embodiments, the pumps 230 include one or more of diaphragm pumps, centrifugal pumps, piston pumps, and/or plunger pumps for each cartridge. Each pump has a rotating motor (e.g., on the motor interface PCBA 234 in FIG. 2) that, together with gravity, causes pigment to exit its associated cartridge when the motor is running. The motor may be a permanent magnet DC motor, a series DC motor, a DC shunt motor, a separately excited motor, a DC compound motor, an AC motor, or any other suitable motor.

The cosmetic dispenser 100 may contain a cartridge for red pigment, yellow pigment, blue pigment, black pigment, white pigment, and/or foundation base. The pigment is formulated for application on the skin, as is the foundation base. The foundation base may be uncolored and is used for bringing up or down the coverage level of foundations. For example, using more foundation base results in a higher coverage level of the resulting foundation compared to using less of the foundation base. Foundation is formed by combining pigment with the foundation base. Pigment and foundation base can be mixed by hand to form the foundation or can be mixed with a mixer configured as part of the cosmetic dispenser.

FIGS. 12 and 13 illustrate removal of cartridges 1000 from the cosmetic dispenser 100. The cartridges 1000 are removable from the cosmetic dispenser 100 for replacement once the pigment contained within runs out. Each cartridge 1000 sits within a cartridge connector (e.g., the connector 210) coupled with a hinge shaft 212. The cartridge 1000 coupled with the connector 210 can pivot outward for removal, as is shown in FIG. 12. Similarly, the cartridge 1000 can be inserted within the cosmetic dispenser by coupling the cartridge 1000 with the cartridge connector 210 coupled with the hinge shaft 212 and pivoting the cartridge 1000 back to the cosmetic dispenser 100. As shown in FIG. 13, the cartridge connector 210 with the hinge shaft 212 is coupled with the cartridge switch PCBA 216 of the cosmetic dispenser 100 (e.g., as described with respect to FIG. 2). The cartridge switch PCBA 216 includes a set of switches, one for each cartridge. The data captured using the switches is used to determine if a cartridge has been changed within the cosmetic dispenser 100.

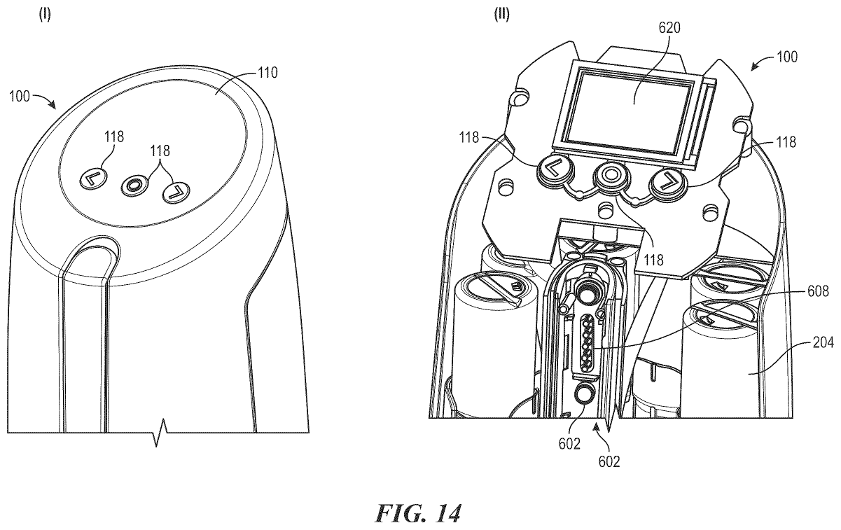

FIG. 14 illustrates exemplary views of a top portion of the cosmetic dispenser 100. Section I of FIG. 14 includes an outer view including the screen 110 and control buttons 118, as described with respect to FIG. 1. The buttons 118 may be capacitive control switches that are able to operate even if exposed to cosmetics or liquid. Section II includes an interior view of the display 620 and the control buttons 118, as described with respect to FIG. 6. Also, Section II of FIG. 14 shows the sub-assembly 204 of FIG. 2 and the scanner holder 605 with the electrical connector 608 and the magnets 606 of FIG. 6. In some embodiments, the screen 110 is a touchscreen configured to receive user input. In such embodiments, one or more of the buttons 118 can be omitted from the cosmetic dispenser 100.

FIG. 15 illustrates operation of the drawer 308 of the cosmetic dispenser 100. Section I of FIG. 15 illustrates the drawer 308 in a closed position. The drawer 308 is coupled with the drawer enclosure 302 and the bottom cover 318. Section II of FIG. 15 illustrates the drawer 308 in an open position so that the drawer 308 is pivoted from the drawer enclosure 302 (e.g., by rotation with help of the screw 306 and drawer spring 304). As shown, the drawer 308 holds a container 1500 (also referred to as a “jar” herein) configured to receive the liquids (e.g., a foundation base and one or more pigments) from the cartridges. The drawer 308 further includes sensors 1504 that capture data used to determine whether the pivoting drawer 308 currently contains a container or not. The drawer 308 further includes an integral molded stop 1502 for the locking mechanism 314, as described with respect to FIG. 3. In some embodiments, the drawer 308 includes a mixing mechanism (e.g., a stirrer) (e.g., see a mixing mechanism 1710 in FIG. 17) configured to mix liquids inside the container 1500 when the container 1500 is placed within the drawer 308. The mixing mechanism can be configured to mix the foundation and one or more pigments in the container 1500 to produce a customized foundation.

In some embodiments, the cosmetic dispenser can be connected via a network to a cosmetic support platform (e.g., via a network interface device 1812 in FIG. 18). The cosmetic support platform provides processes and data for a cosmetic dispenser and/or a mobile application embodied on a mobile device. In some embodiments, the user can control the cosmetic dispenser via a user interface of the mobile application presented on their mobile device. The user may also control the cosmetic dispenser via a set of buttons and other interactive elements directly on the cosmetic dispenser, such that the user does not need to use the mobile application to operate the cosmetic dispenser.

The network can be any type of communications network, such as a local area network (e.g., intranet), wide area network (e.g., Internet), or some combination thereof. The network can also include a direct connection between a mobile device and the cosmetic support platform. In general, communication between the cosmetic support platform can be communicatively coupled to mobile devices over a short-range wireless connectivity technology, such as Bluetooth®, Near Field Communication (NFC), Wi-Fi® Direct (also referred to as “Wi-Fi P2P”), and the like. As an example, the cosmetic support platform is embodied as a mobile application that is executable by a mobile phone or tablet computer. In such embodiments, the mobile phone or tablet computer may be communicatively connected to (i) a cosmetic dispenser and (ii) a computer server via the Internet.

The cosmetic dispenser communicates data captured by its sensors to the cosmetic support platform. The cosmetic support platform can be located at the cosmetic dispenser, such that the user can use the cosmetic dispenser without connection to a network, or can be located external to the cosmetic dispenser. The cosmetic platform may present information via a mobile application at a mobile device of a user to aid in the foundation creation process. For instance, the cosmetic platform may guide a user, via a graphical user interface (GUI) presented at their mobile device, through establishing a connection to the cosmetic dispenser, calibrating the cosmetic dispenser, and scanning their skin for the foundation creation process. The cosmetic support platform can also guide the user through setting up a subscription service. When signed up for the subscription service, the user is automatically sent new cartridges once their cartridges run out (as determined by data from the drip sensors) or on a periodic basis based on how often they typically run out of each cartridge. The user can select what type of foundation base they want to receive (e.g., for a matte effect, a dewy effect, or sun protection) via the GUI and update their choice periodically.

The cosmetic support platform analyzes data received from the cosmetic dispenser to determine how much pigment and foundation base to dispense into the container. For instance, the cosmetic support platform receives data from the scanner indicating a skin tone of the user. The data can describe the skin color and undertone (e.g., shade) of the user's skin. The cosmetic support platform may output a representation of the shade to a screen at the cosmetic dispenser such that the user can approve the color before the cosmetic dispenser dispenses pigment and foundation base.

The cosmetic support platform may additionally or alternatively render a GUI for display via a mobile application at the user's mobile device. The cosmetic support platform may depict the representation of the shade via the GUI along with interactive elements that the user can interact with to approve or adjust (e.g., lighten, darken, change undertone) the shade. The cosmetic support platform can also facilitate a virtual “try-on” of the foundation based on pre-captured or real-time image data of the user, such that the user can see a representation of what the shade of foundation would look like on their face. The user can interact with the GUI to further adjust the shade to increase coverage (e.g., light, medium, full) of the foundation or color correct the foundation, such as to reduce redness. In some embodiments, the cosmetic support platform may alter the representation to correspond with a user's outfit or jewelry. For example, if the user is wearing gold jewelry, they may want the foundation to have a yellow undertone to match the gold.

The cosmetic support platform may apply a machine learned model to data describing the user to determine a shade for the user's foundation. The data can include the data captured by the scanner, previous shades determined for the user, what the user is wearing in an input image, and the like. The machine learned model outputs a shade that can be created using pigments in the cartridges. The machine learned model can be trained on other foundation shades labeled with scanner data, images of users, and the like and can be retrained upon receiving more data from the cosmetic dispensers of other users. The machine learned model may be one or more of a classification model, regression model, deep learning model, neural network, decision tree, or another artificial intelligence algorithm.

The cosmetic support platform may make recommendations to the user based on the selected shade. For instance, the cosmetic support platform may render a GUI depicting other cosmetic products, clothing, and/or accessories (collectively, “products”) in colors that complement the shade. In some embodiments, the cosmetic support platform uses a machine learned model to determine what products the user may like. The cosmetic support platform inputs the shade to the machine learned model, which outputs products that users with similar shades have purchased (or otherwise indicated that they liked via the mobile application). The machine learned model may be trained on other users' shades, each labeled with products that the associated user purchased. The machine learned model can be retrained periodically on new data captured at the cosmetic support platform. This allows the user to see current trends in the fashion market that may complement their skin tone.

Once the cosmetic support platform has received an indication from the user that they approve of the shade, the cosmetic support platform applies a pigment algorithm to determine an amount of each of available pigments (red, yellow, blue, white, black, foundation base) needed to create the shade. Including the color of the foundation base in the calculation allows the cosmetic support platform to control a coverage level of the foundation. For instance, the cosmetic support platform may use a larger amount of foundation base (compared to the other pigments) for light coverage and use a smaller amount of foundation base (compared to the other pigments) for full coverage.

The color algorithm determines a mixture of the available pigments that corresponds to the shade. The color algorithm can convert light color, which is additive, to physical color, which is subtractive. The color algorithm may operate based on one or more of the cyan, magenta, yellow, and black (CMYK) color model and the red, green, and blue (RGB) color model. The color algorithm may use dynamic math, one or more databases, and one or more models to determine the pigments to use to create the shade.

Once the color algorithm has determined the ratio of the pigments needed to create the shade, the cosmetic support platform determines a number of drops of each pigment needed to create the shade based on an amount of foundation base being used. For example, to create 5 milliliters of foundation, the cosmetic support platform may use 50 drops of foundation base and 50 drops of pigments in the determined ratio. For each pigment and the foundation base, the cosmetic support platform causes the motor of the associated cartridge to turn on and receives data describing how many drops have exited the cartridge from the associated drip sensor. The cosmetic support platform causes the motor to turn off such that only the calculated amount of pigment and foundation base are expressed into the container. If the cosmetic platform determines that no drops are being expressed from a cartridge, the cosmetic support platform may send an alert via the mobile application that the cartridge is empty or may automatically order a replacement cartridge for the user. In some embodiments, the cosmetic support platform causes a mixer coupled to the container to mix the pigments and foundation base.

In some embodiments, to increase the flow rate of the pigment and/or foundation base (e.g., liquid), or to prevent leakage from the nozzle, the cosmetic platform causes an associated motor to reverse after the liquid has passed the motor to suck the liquid back up the tubing associated with the liquid, which heats up the liquid. The motor re-reverses to express the liquid into the container, either through the same tube or a connected tube.

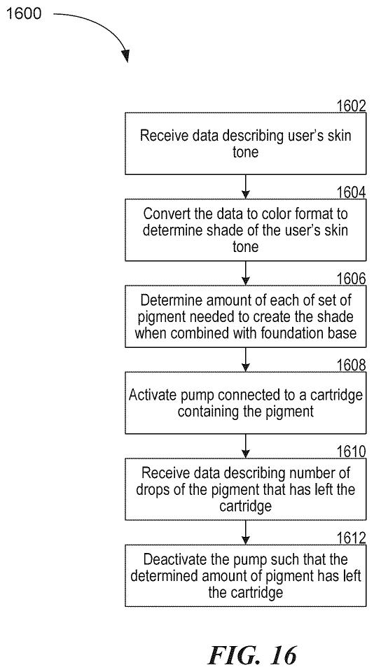

FIG. 16 is a flow diagram that illustrates processes 1600 for creating a custom foundation. The custom foundation is configured to have a customized shade that matches with a skin tone of a user. The process 1600 can be performed with a cosmetic device (e.g., the cosmetic dispenser 100 and its various components described in this specification). In some embodiments, device includes the computer system 1800 described with respect to FIG. 18, or portions of it.

At 1602, the device can receive data describing a user's skin tone from a skin color sensor (e.g., the scanner 108 in FIG. 1). In some embodiments, the device can collect the data describing the user's skin tone with the skin color sensor. The skin color sensor is removable from the device (e.g., as shown in FIG. 5). Subsequent to the data collection, the skin color sensor can be electronically coupled to a base of the cosmetic dispenser and transmitting the data from the skin color sensor to the cosmetic dispenser. The skin color sensor and its operation are described with respect to FIGS. 5 through 9.

At 1604, the device can convert the data to a color format to determine a shade of the user's skin tone.

At 1606, the device can determine an amount of each of a set of pigments needed to create the shade when combined with a foundation base. For example, the pigments can include a red, green, blue, black, yellow, cyan, magenta, and/or white colored pigment. The foundation base can be a colorless/white liquid that is formulated to create an even complexion when applied to skin.

For each pigment, at 1608 the device can activate a pump (e.g., the pumps 230 in FIG. 2) connected to a cartridge (e.g., the cartridges 236 in FIG. 2) containing the pigment. The cartridge containing the pigment can include a flexible bag configured to collapse as the pigment leaves the cartridge. The cartridges are described with respect to FIGS. 10 and 11.

At 1610, the device can receive for each pigment data describing a number of drops of the pigment that has left the cartridge from a drip sensor positioned at an end of the cartridge. In some embodiments, the device can heat the pigment during dispensing of pigment from the respective cartridge by a heater coupled to the pump.

At 1612, the device can deactivate the pump such that the determined amount of pigment has left the cartridge. The device can combine the number of drops of the pigment with the foundation base to create a custom foundation having the shade of the user's skin tone. For example, the pigments and the foundation base are dispensed to a container (e.g., the container 1500 in FIG. 15). The container can be removed from the device and mixed to form a uniform custom foundation having the shade of the user's skin tone.

### Exemplary Embodiments

FIG. 17 is a block diagram illustrating some components of the cosmetic dispenser 100. In some embodiments, the cosmetic dispenser includes a base and a wand structure. The can base can include multiple cartridge receptacles (e.g., cartridge connectors) configured to receive removable cartridges (e.g., cartridges 236 in FIG. 2 and cartridge 1000 in FIGS. 10 and 11). Each of the removable cartridges can be configured to contain a different pigment. The base can include multiple pumps (e.g., the pumps 230 in FIG. 2). Each of the pumps can be coupled to a respective cartridge receptacle of the cartridges and configured to dispense pigment from the respective cartridge to a container. The wand structure can include a scanner (e.g., the scanner 108 in FIG. 1) including a skin color sensor configured to capture data indicative of a user's skin tone. The wand structure can be physically removable from the base to operate the scanner. The dispenser can also include a cavity (e.g., FIGS. 5 through 9) configured to receive the wand structure and electrically couple to the base.

The dispenser can include a controller (e.g., a PCBA such as any of the PCBAs 216, 234, and 228) configured to receive the data indicative of the user's skin color from the wand structure when the wand structure is disposed in the cavity of the base and electrically coupled to the controller. The controller can determine an amount of each pigment in the cartridges needed to create a cosmetic foundation having a shade of the user's skin color when combined with a foundation base. The controller can cause one or more of the pumps to dispense from respective cartridges the amount of each pigment needed to create the cosmetic foundation having the shade of the user's skin tone when combined with the foundation base in the container.

In some embodiments, the cosmetic dispenser further includes drip sensors (e.g., the drip sensor assemblies 1702 including light sources 1704 and light detectors 1706). Each of the drip sensors can be coupled to an end of a respective cartridge. Each of the drip sensors can be configured to detect an amount of pigment dispensed from the respective cartridge. The controller can be configured to deactivate the one or more of the pumps when the drip sensors detect that the amount of each pigment needed has been dispensed.

In some embodiments, the cosmetic dispenser further includes one or more heaters coupled to the pumps (e.g., see heaters 1708 in FIG. 17). The one or more heaters can be configured to heat the pigment during the dispensing of pigment from the respective cartridge.

In some embodiments, the skin color sensor (e.g., the skin color sensor 1712) includes a photoelectric sensor or a Light Detection and Ranging (LIDAR) sensor.

In some embodiments, the scanner includes a touch sensor (e.g., the touch sensor 1714) configured to determine whether the scanner is in contact with the user's skin.

In some embodiments, the cavity is a cylindrical cavity (e.g., the cylindrical cavity in FIG. 8) or a notch cavity (e.g., the notch cavity 502 in FIG. 6) at least partially surrounded by the base. The wand structure can be removable from the cylindrical cavity or the notch so that the scanner can be uncoupled from the cosmetic dispenser to measure the user's skin color. In some embodiments, the wand structure can be configured to be inserted into the cavity to electrically couple to the base.

In some embodiments, the wand structure is configured to be disposed in the cavity so that a portion of an outer surface of the wand structure forms a portion of an outer surface of the base when the wand structure is disposed in the cavity (e.g., see FIG. 1).

In some embodiments, the cosmetic dispenser further includes a foundation base cartridge receptacle (e.g., the cartridge connectors 210) configured to receive a foundation base cartridge configured to contain the base for the foundation. The cosmetic dispenser can include an additional pump configured to dispense the foundation base from the foundation base cartridge to the container. The controller can be further configured to cause the additional pump to dispense an amount of foundation base from the foundation base cartridge to the container.

In some embodiments, the controller is further configured to determine the shade of the user's skin tone by converting the data indicative of the user's skin color into a color format.

In some embodiments, the pigments include a red, green, blue, black, yellow, cyan, magenta, and/or white colored pigment.

In some embodiments, the cartridges include flexible bags configured to collapse as pigment is dispensed from the cartridges (e.g., FIG. 11).

In some embodiments, the pumps include peristaltic pumps, diaphragm pumps, centrifugal pumps, piston pumps, or plunger pumps.

In some embodiments, the base further includes a mixer (e.g., the mixing mechanism 1710) configured to mix the container including the dispensed pigments and the base in the container.

In some embodiments, a cosmetic dispenser (e.g., the cosmetic dispenser 100 in FIG. 1) includes a base including one or more receptacles configured to hold removable cartridges. Each cartridge can contain a different pigment. The base can include one or more pumps. Each pump can be coupled to one of the one or more cartridges. Pigment can be expressed from the cartridge when the pump is on (activated). The base includes a heater that heats pigment after the pigment has traveled through one of the one or more pumps. The base can include one or more drip sensors. Each drip sensor can be coupled to an end portion of one of the one or more cartridges. The cosmetic dispenser can include (or be configured to communicate with) a scanner including a photoelectric sensor at the end of a wand structure. The photoelectric sensor captures data describing color. The cosmetic dispenser can include a circuit board connected to the one or more pumps, the heater, the one or more drip sensors, and the photoelectric sensor for data capture. The cosmetic sensor can include a processor that receives data from the circuit board. The processor can include instructions that, when executed, cause the processor to receive data describing a user's skin tone from the scanner. The processor can convert the data to a color format to determine a shade of the user's skin tone and determine an amount of each pigment in the removable cartridges needed to create the shade when combined with a foundation base. For each pigment, the processor can activate a pump of the pumps connected to a cartridge containing the pigment and receive data describing a number of drops of the pigment that has left the cartridge from a sensor positioned at an end of the cartridge. The processor can deactivate the pump such that the determined amount of pigment has left the cartridge.

### Computer System

FIG. 18 is a block diagram that illustrates an example of a computer system 1800 in which at least some operations described herein can be implemented. As shown, the computer system 1800 can include: one or more processors 1802, main memory 1806, non-volatile memory 1810, a network interface device 1812, video display device 1818, an input/output device 1820, a control device 1822 (e.g., keyboard and pointing device), a drive unit 1824 that includes a storage medium 1826, and a signal generation device 1830 that are communicatively connected to a bus 1816. The bus 1816 represents one or more physical buses and/or point-to-point connections that are connected by appropriate bridges, adapters, or controllers. Various common components (e.g., cache memory) are omitted from FIG. 18 for brevity. Instead, the computer system 1800 is intended to illustrate a hardware device on which components illustrated or described relative to the examples of the figures and any other components described in this specification can be implemented.

The computer system 1800 can take any suitable physical form. For example, the computer system 1800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 1800. In some implementation, the computer system 1800 can be an embedded computer system, a system-on-chip (SOC), a single-board computer system (SBC) or a distributed system such as a mesh of computer systems or include one or more cloud components in one or more networks. Where appropriate, one or more computer systems 1800 can perform operations in real-time, near real-time, or in batch mode.

The network interface device 1812 enables the computer system 1800 to mediate data in a network 1814 with an entity that is external to the computer system 1800 through any communication protocol supported by the computer system 1800 and the external entity. Examples of the network interface device 1812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1806, non-volatile memory 1810, machine-readable medium 1826) can be local, remote, or distributed. Although shown as a single medium, the machine-readable medium 1826 can include multiple media (e.g., a centralized/distributed database and/or associated caches and servers) that store one or more sets of instructions 1828. The machine-readable (storage) medium 1826 can include any medium that is capable of storing, encoding, or carrying a set of instructions for execution by the computer system 1800. The machine-readable medium 1826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1804, 1808, 1828) set at various times in various memory and storage devices in computing device(s). When read and executed by the processor 1802, the instruction(s) cause the computer system 1800 to perform operations to execute elements involving the various aspects of the disclosure.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification unless those terms are explicitly defined herein. Accordingly, the actual scope of the technology encompasses not only the disclosed embodiments but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description but rather by any claims that issue on an application based hereon. Accordingly, the disclosure of various embodiments is intended to be illustrative, but not limiting, of the scope of the technology as set forth in the following claims.

I/We claim:

1. A cosmetic dispenser comprising:
a base comprising:
multiple cartridge receptacles configured to receive removable cartridges, each of the removable cartridges being configured to contain a different pigment; and
multiple pumps, each of the pumps coupled to a respective cartridge receptacle of the cartridges and configured to dispense pigment from the respective cartridge to a container; and
a wand structure comprising:
a scanner including a skin color sensor configured to capture data indicative of a user's skin tone, the wand structure being physically removable from the base to operate the scanner;
a cavity configured to receive the wand structure and electrically couple to the base;
a controller configured to:
receive, from the wand structure, when disposed in the cavity of the base and electrically coupled to the controller, the data indicative of the user's skin color,
determine an amount of each pigment in the cartridges needed to create a cosmetic foundation having a shade of the user's skin color when combined with a foundation base, and
cause one or more of the pumps to dispense, from respective cartridges, the amount of each pigment needed to create the cosmetic foundation having the shade of the user's skin tone when combined with the foundation base in the container.

2. The cosmetic dispenser of claim 1, further comprising:
drip sensors, each of the drip sensors coupled to an end of a respective cartridge,
wherein each of the drip sensors is configured to detect an amount of pigment dispensed from the respective cartridge, and
wherein the controller is configured to deactivate the one or more of the pumps when the drip sensors detect that the amount of each pigment needed has been dispensed.

3. The cosmetic dispenser of claim 1, further comprising:
a heater coupled to the pumps, the heater configured to heat the pigment during dispensing of pigment from the respective cartridge.

4. The cosmetic dispenser of claim 1, wherein the skin color sensor comprises:
a photoelectric sensor or a Light Detection and Ranging (LIDAR) sensor.

5. The cosmetic dispenser of claim 1, wherein the scanner comprises:
a touch sensor configured to determine whether the scanner is in contact with the user's skin.

6. The cosmetic dispenser of claim 1,
wherein the cavity is a cylindrical cavity or a notch cavity at least partially surrounded by the base, and
wherein the wand structure is removable from the cylindrical cavity or the notch so that the scanner can be uncoupled from the cosmetic dispenser to measure the user's skin color.

7. The cosmetic dispenser of claim 1,
wherein the wand structure is configured to be inserted into the cavity to electrically couple to the base.

8. The cosmetic dispenser of claim 1,
wherein the wand structure is configured to be disposed in the cavity so that a portion of an outer surface of the wand structure forms a portion of an outer surface of the base when the wand structure is disposed in the cavity.

9. The cosmetic dispenser of claim 1, further comprising:
a foundation base cartridge receptacle configured to receive a foundation base cartridge configured to contain the base for the foundation; and
an additional pump configured to dispense the foundation base from the foundation base cartridge to the container,
wherein the controller is further configured to cause the additional pump to dispense an amount of foundation base from the foundation base cartridge to the container.

10. The cosmetic dispenser of claim 1, wherein the controller is further configured to:
determine the shade of the user's skin tone by converting the data indicative of the user's skin color into a color format.

11. The cosmetic dispenser of claim 1,
wherein the pigments include a red, green, blue, black, yellow, cyan, magenta, and/or white colored pigment.

12. The cosmetic dispenser of claim 1,
wherein the cartridges include flexible bags configured to be compressed by air when pigment is dispensed from the cartridges.

13. The cosmetic dispenser of claim 1,
wherein the pumps include peristaltic pumps, diaphragm pumps, centrifugal pumps, piston pumps, or plunger pumps.

14. The cosmetic dispenser of claim 1, wherein the base further comprises:
a mixer configured to mix the container including the dispensed pigments and the base in the container.

15. A method for creating a custom foundation by a cosmetic dispenser, the method comprising:
receiving, from a skin color sensor, data describing a user's skin tone;
converting the data to a color format to determine a shade of the user's skin tone;
determining an amount of each of a set of pigments needed to create the shade when combined with a foundation base; and
for each pigment:
activating a pump connected to a cartridge containing the pigment;
receiving, from a drip sensor positioned at an end of the cartridge, data describing a number of drops of the pigment that has left the cartridge; and
deactivating the pump such that the determined amount of pigment has left the cartridge.

16. The method of claim 15, further comprising:
collecting the data describing the user's skin tone with the skin color sensor,
wherein the skin color sensor is removable from the cosmetic dispenser; and
subsequent to the data collection,
electronically coupling the skin color sensor to a base of the cosmetic dispenser, and
transmitting the data from the skin color sensor to the cosmetic dispenser.

17. The method of claim 15,
wherein the cartridge containing the pigment comprises a flexible bag configured to be compressed by air when the pigment leaves the cartridge.

18. The method of claim 15, further comprising:
heating, by a heater coupled to the pump, the pigment during dispensing of pigment from the respective cartridge.

19. The method of claim 15, further comprising:
combining the number of drops of the pigment with the foundation base to create a custom foundation having the shade of the user's skin tone.

20. A cosmetic dispenser comprising:
a base comprising:
one or more receptacles configured to hold removable cartridges, each cartridge containing a different pigment;
one or more pumps, each coupled to one of the one or more cartridges, wherein pigment is expressed from the cartridge when the pump is on; and
one or more drip sensors, each coupled to an end portion of one of the one or more cartridges;
a scanner comprising:
a photoelectric sensor at the end of a wand structure, wherein the photoelectric sensor captures data describing color;
a circuit board connected to the one or more pumps, the heater, the one or more drip sensors, and the photoelectric sensor for data capture; and
a processor that receives data from the circuit board, wherein the processor includes instructions that, when executed, cause the processor to:
receive, from the scanner, data describing a user's skin tone;
convert the data to a color format to determine a shade of the user's skin tone;
determine an amount of each pigment in the removable cartridges needed to create the shade when combined with a foundation base; and
for each pigment:
activate a pump of the pumps connected to a cartridge containing the pigment;
receive, from a sensor positioned at an end of the cartridge, data describing a number of drops of the pigment that has left the cartridge; and
deactivate the pump such that the determined amount of pigment has left the cartridge.
